(19) United States
(12) Patent Application Publication
(10) Pub. No.: US 2025/0392369 A1
(43) Pub. Date: Dec. 25, 2025

(54) BEAM REPORTS WITH FREQUENCY RESOURCE UNIT GRANULARITY

(71) Applicant: QUALCOMM Incorporated, San Diego, CA (US)

(72) Inventors: Wei XI, Beijing (CN); Min HUANG, Beijing (CN); Chao WEI, Beijing (CN); Hao XU, Beijing (CN); Liangming WU, Beijing (CN); Chenxi HAO, Beijing (CN); Rui HU, Beijing (CN); Jing DAI, Beijing (CN)

(21) Appl. No.: 18/880,329

(22) PCT Filed: Aug. 22, 2022
(86) PCT No.: PCT/CN2022/113857

§ 371 Date: Dec. 31, 2024

(51) Int. Cl. H04B 7/06

(52) U.S. Cl. CPC H04B 7/06952; H04B 7/0626

(57) ABSTRACT

Various aspects of the present disclosure generally relate to wireless communication. In some aspects, a user equipment (UE) may receive a plurality of reference signals (RSS) over a frequency bandwidth, each RS of the plurality of RSs being associated with a respective candidate beam of a plurality of candidate beams. The UE may transmit a multi-part beam report, the multi-part beam report including: a first part that indicates one or more of a quantity of beams indicated in the multi-part report, or a quantity of frequency resource units (FRUs) indicated in the multi-part beam report, and a second part that indicates, based on the measurements of the plurality of RSs, an association of a first beam with a first FRU of the FRUs, and an association of a second beam with a second FRU of the FRUs. Numerous other aspects are provided.

### FIELD OF THE DISCLOSURE

Aspects of the present disclosure generally relate to wireless communication and specifically, to techniques and apparatuses for beam reports with frequency resource unit (FRU) granularity.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some networks, beamforming may be used to direct communications along a beam path toward a receiving wireless communication device. A transmitting wireless communication device may apply precoding to a signal before providing the signal to antenna elements for transmission. The precoding provides the signal with timing, rotation, or weighting that, when transmitted via respective antenna elements, steers the signal in the form of a directional beam. In some devices, spacing of the antenna elements is also configured to assist in steering the signal. However, the spacing of the antenna elements may steer the signal to different angles based on different frequencies (for example, carrier frequencies) of the signal. In some networks, the transmitting wireless communication device may transmit a communication having signals using a broad frequency bandwidth where a variation of steering at a low end of the frequency bandwidth and steering at a high end of the frequency bandwidth causes reduced signal strength as received at a receiving wireless communication device, which may cause communication errors that consume power, processing, communication, and network resources to detect and correct. Additionally or alternatively, the communication errors may cause wireless communication devices to limit a size of the frequency bandwidth to reduce the variation at ends of the frequency bandwidth.

### SUMMARY

Some aspects described herein relate to a method of wireless communication performed by a user equipment (UE). The method may include receiving an indication of one or more parameters for transmission of a multi-part beam report associated with a beam management procedure. The method may include receiving a plurality of reference signals (RSs) over a frequency bandwidth, each RS of the plurality of RSs being associated with a respective candidate beam of a plurality of candidate beams. The method may include transmitting the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to a method of wireless communication performed by a network node. The method may include transmitting an indication of one or more parameters for transmission of a multi-part beam report associated with a beam management procedure. The method may include transmitting a plurality of RSs over a frequency bandwidth, each RS of the plurality of RSs being associated with a respective candidate beam of a plurality of candidate beams. The method may include receiving the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to a UE for wireless communication. The user equipment may include at least one processor and at least one memory, communicatively coupled with the at least one processor, that stores processor-readable code. The processor-readable code, when executed by the at least one processor, may be configured to cause the user equipment to receive an indication of one or more parameters for transmission of a multi-part beam report associated with a beam management procedure. The processor-readable code, when executed by the at least one processor, may be configured to cause the user equipment to receive a plurality of RSs over a frequency bandwidth, each RS of the plurality of RSs being associated with a respective candidate beam of a plurality of candidate beams. The processor-readable code, when executed by the at least one processor, may be configured to cause the user equipment to transmit the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit an indication of one or more parameters for transmission of a multi-part beam report associated with a beam management procedure. The processor-readable code, when executed by the at least one processor, may be configured to cause the network node to transmit a plurality of RSs over a frequency bandwidth, each RS of the plurality of RSs being associated with a respective candidate beam of a plurality of candidate beams. The processor-readable code, when executed by the at least one processor, may be configured to cause the network node to receive the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to a non-transitory computer-readable medium that stores a set of instructions for wireless communication by a UE. The set of instructions, when executed by one or more processors of the UE, may cause the UE to receive an indication of one or more parameters for transmission of a multi-part beam report associated with a beam management procedure. The set of instructions, when executed by one or more processors of the UE, may cause the UE to receive a plurality of RSs over a frequency bandwidth, each RS of the plurality of RSs being associated with a respective candidate beam of a plurality of candidate beams. The set of instructions, when executed by one or more processors of the UE, may cause the UE to transmit the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to a non-transitory computer-readable medium that stores a set of instructions for wireless communication by a network node. The set of instructions, when executed by one or more processors of the network node, may cause the network node to transmit an indication of one or more parameters for transmission of a multi-part beam report associated with a beam management procedure. The set of instructions, when executed by one or more processors of the network node, may cause the network node to transmit a plurality of RSs over a frequency bandwidth, each RS of the plurality of RSs being associated with a respective candidate beam of a plurality of candidate beams. The set of instructions, when executed by one or more processors of the network node, may cause the network node to receive the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs. Some aspects described herein relate to an apparatus for wireless

communication. The apparatus may include means for receiving an indication of one or more parameters for transmission of a multi-part beam report associated with a beam management procedure. The apparatus may include means for receiving a plurality of RSs over a frequency bandwidth, each RS of the plurality of RSs being associated with a respective candidate beam of a plurality of candidate beams. The apparatus may include means for transmitting the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Some aspects described herein relate to an apparatus for wireless communication. The apparatus may include means for transmitting an indication of one or more parameters for transmission of a multi-part beam report associated with a beam management procedure. The apparatus may include means for transmitting a plurality of RSs over a frequency bandwidth, each RS of the plurality of RSs being associated with a respective candidate beam of a plurality of candidate beams. The apparatus may include means for receiving the multi-part beam report based on the one or more parameters. The multi-part beam report may include a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report. The multi-part beam report may include a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example beamforming architecture that supports beamforming for millimeter wave (mmW) communications, in accordance with the present disclosure.

FIG. 6 is a diagram illustrating an example of a set of beam directions formed using a same precoding vector or weights for a signal transmitted on different frequencies, in accordance with the present disclosure.

FIG. 7 is a diagram of an example associated with beam reports with frequency resource units (FRUs) granularity, in accordance with the present disclosure.

FIG. 8 is a flowchart illustrating an example process performed, for example, by a UE that supports beam reports with FRU granularity, in accordance with the present disclosure.

FIG. 9 is a flowchart illustrating an example process performed, for example, by a network node that supports beam reports with FRU granularity, in accordance with the present disclosure.

FIG. 10 is a diagram of an example apparatus, for wireless communication, that supports beam reports with FRU granularity, in accordance with the present disclosure.

FIG. 11 is a diagram of an example apparatus for wireless communication, that supports beam reports with FRU granularity, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to generating and transmitting beam reports that indicate respective beams for different frequency resource units (FRUs) of a frequency bandwidth used for communication between a user equipment (UE) and a network node. Some aspects more specifically relate to indicating a respective preferred beam for each of multiple FRUs of the frequency bandwidth. In some aspects, the beam report may be a multi-part beam report. The multi-part beam report may include a first part that indicates a quantity of beams or a quantity of FRUs that are indicated in a second part of the report. The first part may have a fixed payload size. The second part may indicate pairs of beams and FRUs. For example, the second part may indicate an FRU of the FRUs and an association of the FRU with a beam of the beams (for example, a recommended beam that is recommended to be used with the first FRU). Additionally or alternatively, the second part may indicate the beam and an association of the beam with the FRU.

Particular aspects of the subject matter described in this disclosure can be implemented to realize one or more of the following potential advantages. In some examples, the described techniques can be used to reduce communication errors associated with variation in steering angles of signals at ends of a frequency bandwidth used for a communication. Additionally or alternatively, the described techniques may inform a network node of an optimal beam on scheduled or allocated frequency resources for each UE or on each FRU. For example, the network node may use one or more beams for each UE, depending on an extent to which the UE suffers from frequency-dependent variations in beam steering angles. Moreover, the network node and UE may communicate using the described techniques for improved beam selection with reduced overhead, when compared to using multiple component carriers (for example, having independent beam selections) for a same frequency bandwidth. In some examples, to reduce overhead, the beam selection may be communicated using a multi-part beam report, as described herein.

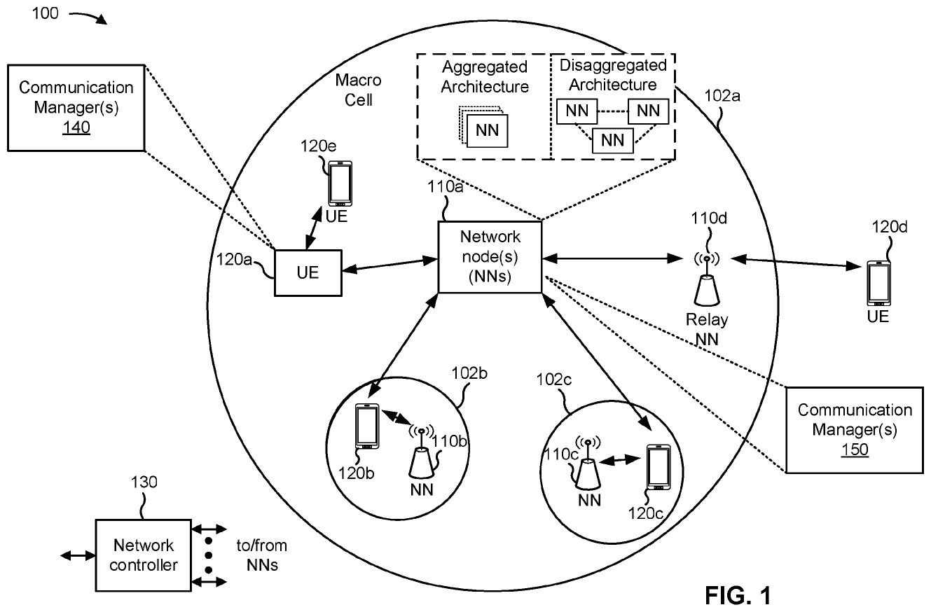

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication of one or more parameters for transmission of a multi-part beam report associated with a beam management procedure; receive a plurality of reference signals (RSs) over a frequency bandwidth, each RS of the plurality of RSs being associated with a respective candidate beam of a plurality of candidate beams; and transmit the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs. Additionally or alternatively, the communication manager 140 may perform one or more other operations described herein.

In some aspects, the network node may include a communication manager 150. As described in more detail elsewhere herein, the communication manager 150 may transmit an indication of one or more parameters for transmission of a multi-part beam report associated with a beam management procedure; transmit a plurality of RSs over a frequency bandwidth, each RS of the plurality of RSs being associated with a respective candidate beam of a plurality of candidate beams; and receive the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs. Additionally or alternatively, the communication manager 150 may perform one or more other operations described herein.

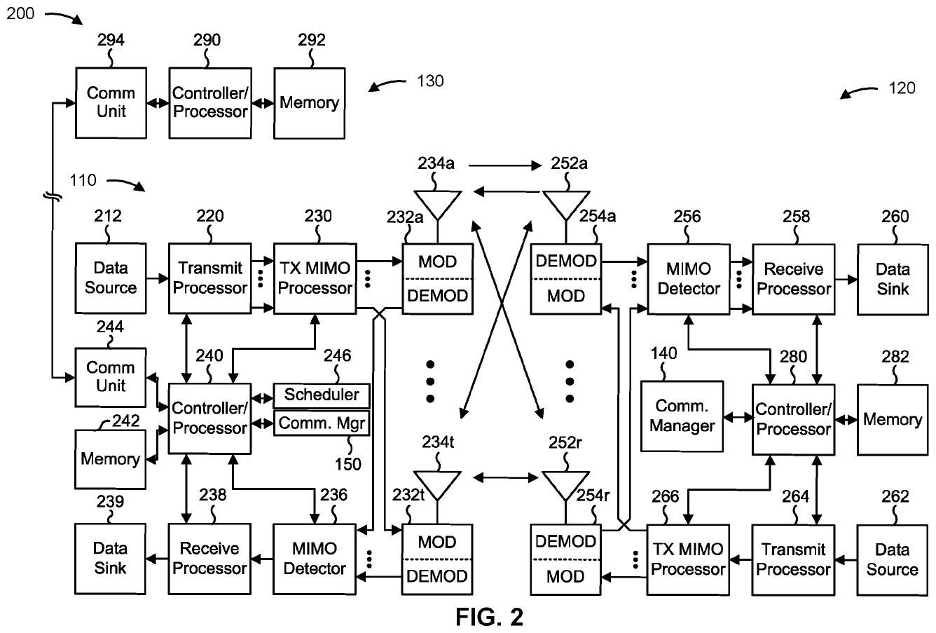

FIG. 2 is a diagram 200 illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based on one or more channel quality indicators (CQIs) received from that UE 120. The network node 110 may process (for example, encode and modulate) the data for the UE 120 based on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include

RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

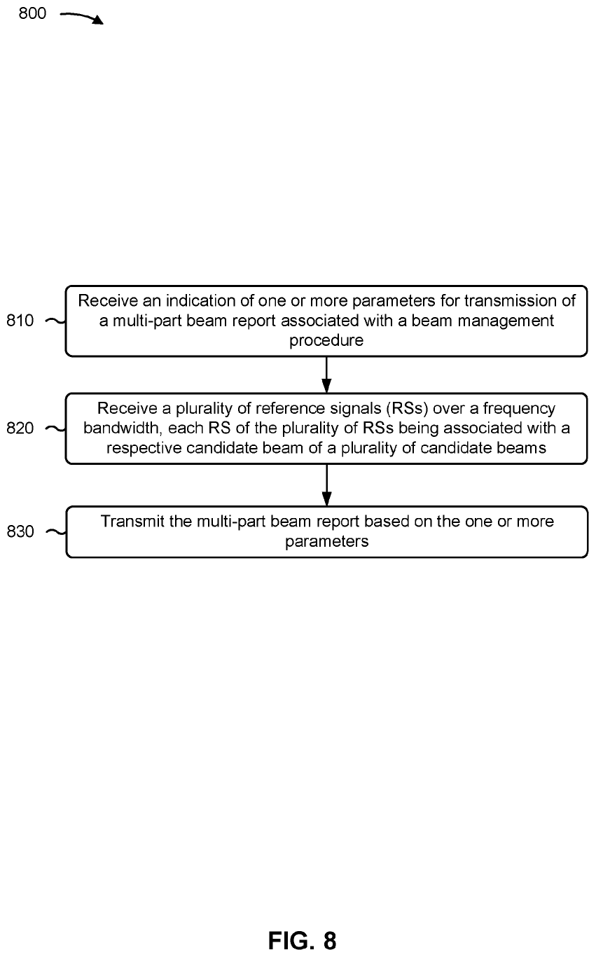

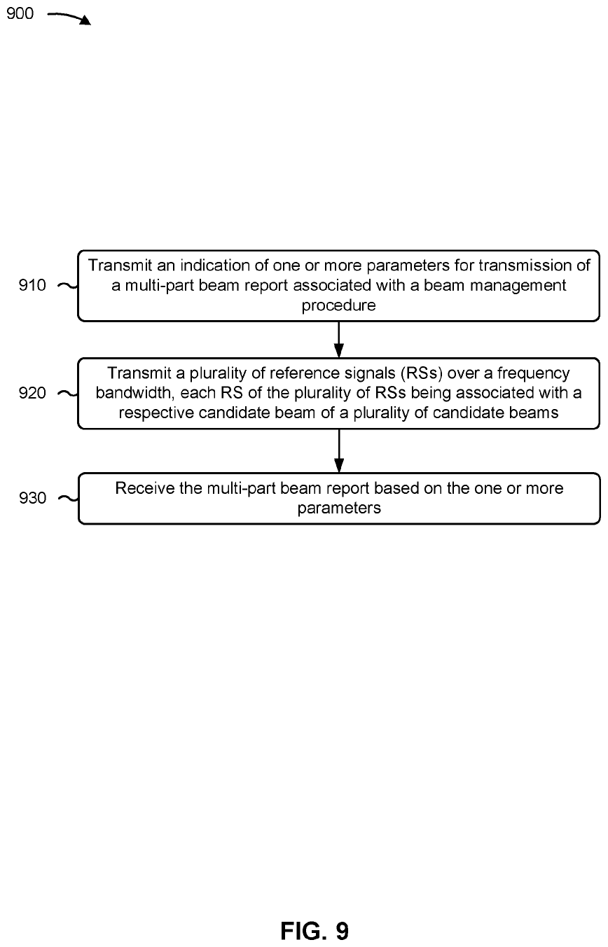

The controller/processor 240 of the network node 110, the controller/processor 280 of the UE 120, or any other component(s) of FIG. 2 may perform one or more techniques associated with beam reports with FRU granularity, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, or other processes as described herein. In some examples, executing instructions may include running the instructions, converting the instructions, compiling the instructions, or interpreting the instructions, among other examples.

In some aspects, the UE includes means for receiving an indication of one or more parameters for transmission of a multi-part beam report associated with a beam management procedure; means for receiving a plurality of RSs over a frequency bandwidth, each RS of the plurality of RSs being associated with a respective candidate beam of a plurality of candidate beams; or means for transmitting the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of one or more parameters for transmission of a multi-part beam report associated with a beam management procedure; means for transmitting a plurality of RSs over a frequency bandwidth, each RS of the plurality of RSs being associated with a respective candidate beam of a plurality of candidate beams; or means for receiving the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

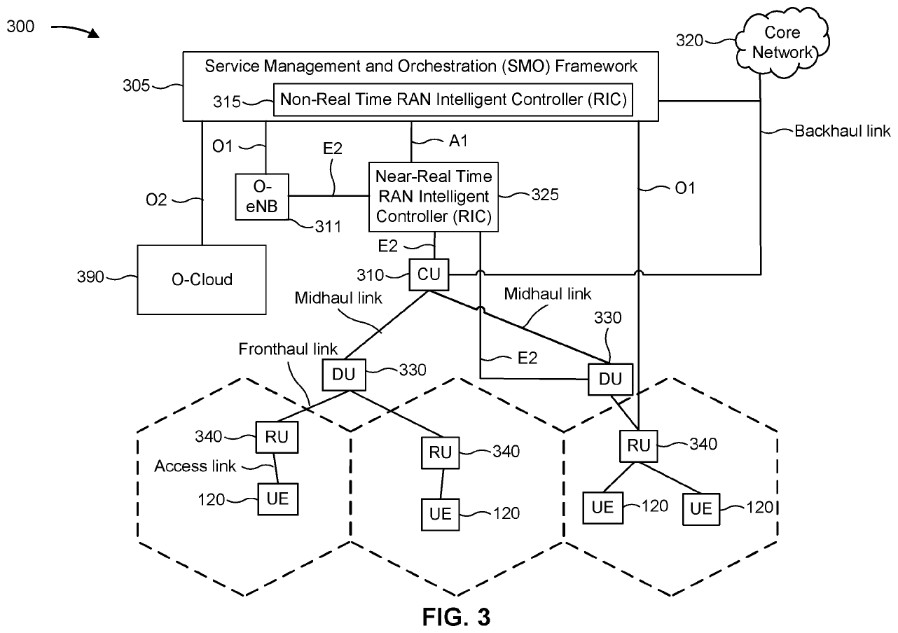

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

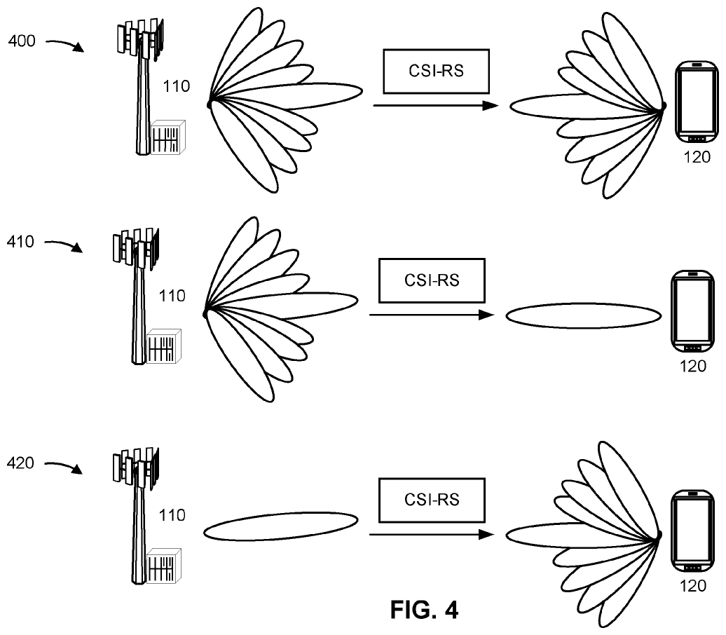

FIG. 4 is a diagram illustrating examples 400, 410, and 420 of beam management procedures (for example, channel state information reference signals (CSI-RSs) beam management procedures), in accordance with the present disclosure. As shown in FIG. 4, examples 400, 410, and 420 include a UE 120 in communication with a network node 110 in a wireless network (for example, wireless network 100). However, the devices shown in FIG. 4 are provided as examples, and the wireless network may support communication and beam management between other devices (for example, between a UE 120 and a network node 110 or TRP, between a mobile termination node and a control node, between an (IAB child node and an IAB parent node, or between a scheduled node and a scheduling node). In some aspects, the UE 120 and the network node 110 may be in a connected state (for example, an RRC connected state).

As shown in FIG. 4, example 400 may include a network node 110 (for example, one or more network node devices such as an RU, a DU, or a CU, among other examples) and a UE 120 communicating to perform beam management using CSI-RSs. Example 400 depicts a first beam management procedure (for example, P1 CSI-RS beam management). The first beam management procedure may be referred to as a beam selection procedure, an initial beam acquisition procedure, a beam sweeping procedure, a cell search procedure, or a beam search procedure. As shown in FIG. 4 and example 400, CSI-RSs may be configured to be transmitted from the network node 110 to the UE 120. The CSI-RSs may be configured to be periodic (for example, using RRC signaling), semi-persistent (for example, using MAC control element (MAC-CE) signaling), or aperiodic (for example, using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (for example, with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (for example, P2 CSI-RS beam management). The second beam management procedure may be referred to as a beam refinement procedure, a network node beam refinement procedure, a TRP beam refinement procedure, or a transmit beam refinement procedure. As shown in FIG. 4 and example 410, CSI-RSs may be configured to be transmitted from the network node 110 to the UE 120. The CSI-RSs may be configured to be aperiodic (for example, using DCI). The second beam management procedure may include the network node 110 performing beam sweeping over one or more transmit beams. The one or more transmit beams may be a subset of all transmit beams associated with the network node 110 (for example, determined based on measurements reported by the UE 120 in connection with the first beam management procedure). The network node 110 may transmit a CSI-RS using each transmit beam of the one or more transmit beams for beam management. The UE 120 may measure each CSI-RS using a single (for example, a same) receive beam (for example, determined based on measurements performed in connection with the first beam management procedure). The second beam management procedure may enable the network node 110 to select a best transmit beam based on measurements of the CSI-RSs (for example, measured by the UE 120 using the single receive beam) reported by the UE 120.

As shown in FIG. 4, example 420 depicts a third beam management procedure (for example, P3 CSI-RS beam management). The third beam management procedure may be referred to as a beam refinement procedure, a UE beam refinement procedure, or a receive beam refinement procedure. As shown in FIG. 4 and example 420, one or more CSI-RSs may be configured to be transmitted from the network node 110 to the UE 120. The CSI-RSs may be configured to be aperiodic (for example, using DCI). The third beam management process may include the network node 110 transmitting the one or more CSI-RSs using a single transmit beam (for example, determined based on measurements reported by the UE 120 in connection with the first beam management procedure or the second beam management procedure). To enable the UE 120 to perform receive beam sweeping, the network node may use a transmit beam to transmit (for example, with repetitions) CSI-RS at multiple times within the same RS resource set so that UE 120 can sweep through one or more receive beams in multiple transmission instances. The one or more receive beams may be a subset of all receive beams associated with the UE 120 (for example, determined based on measurements performed in connection with the first beam management procedure or the second beam management procedure). The third beam management procedure may enable the network node 110 or the UE 120 to select a best receive beam based on reported measurements received from the UE 120 (for example, of the CSI-RS of the transmit beam using the one or more receive beams).

In some networks, the beam management procedures described in connection with FIG. 4 may be performed for an entire frequency bandwidth used for communications between the UE 120 and the network node 110. In some networks, the beam management procedures may be performed per component carrier. However, per-component carrier beam management may consume power, computing, network, and communication resources.

Other examples of beam management procedures may differ from what is described with respect to FIG. 4. For example, the UE 120 and the network node 110 may perform the third beam management procedure before performing the second beam management procedure, or the UE 120 and the network node 110 may perform a similar beam management procedure to select a UE transmit beam.

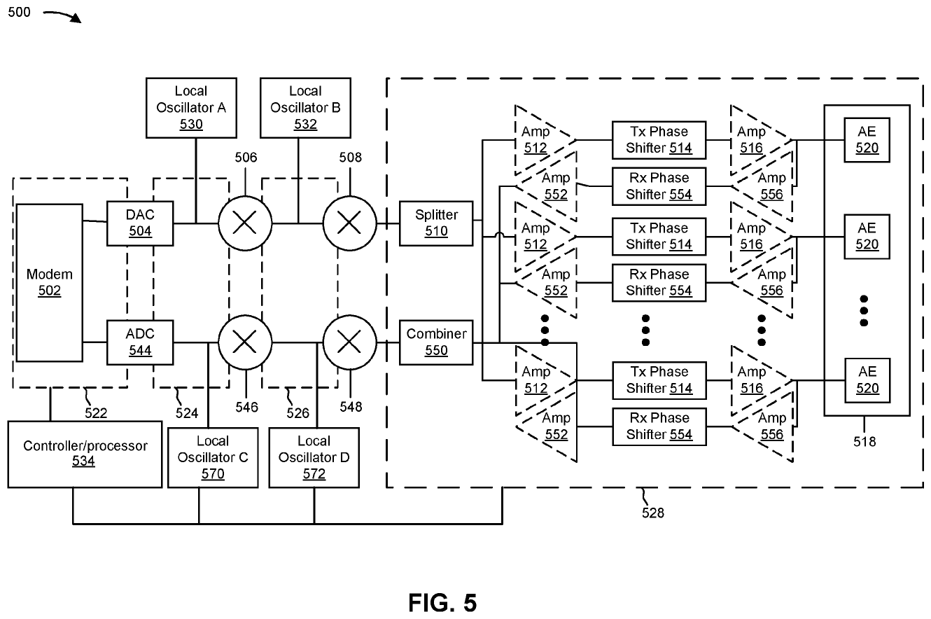

FIG. 5 is a diagram illustrating an example beamforming architecture 500 that supports beamforming for millimeter wave (mmW) communications, in accordance with the present disclosure. In some aspects, architecture 500 may implement aspects of wireless network 100. In some aspects, architecture 500 may be implemented in a transmitting device (for example, a first wireless communication device, UE, or network node) or a receiving device (for example, a second wireless communication device, UE, or network node), as described herein.

Broadly, FIG. 5 is a diagram illustrating example hardware components of a wireless communication device in accordance with certain aspects of the disclosure. The illustrated components may include those that may be used for antenna element selection or for beamforming for transmission of wireless signals. There are numerous architectures for antenna element selection and implementing phase shifting, only one example of which is illustrated here. The architecture 500 includes a modem (modulator/demodulator) 502, a digital to analog converter (DAC) 504, a first mixer 506, a second mixer 508, and a splitter 510. The architecture 500 also includes multiple first amplifiers 512, multiple phase shifters 514, multiple second amplifiers 516, and an antenna array 518 that includes multiple antenna elements 520. In some examples, the modem 502 may be one or more of the modems 232 or modems 254 described in connection with FIG. 2.

Transmission lines or other waveguides, wires, or traces are shown connecting the various components to illustrate how signals to be transmitted may travel between components. Reference numbers 522, 524, 526, and 528 indicate regions in the architecture 500 in which different types of signals travel or are processed. Specifically, reference number 522 indicates a region in which digital baseband signals travel or are processed, reference number 524 indicates a region in which analog baseband signals travel or are processed, reference number 526 indicates a region in which analog intermediate frequency (IF) signals travel or are processed, and reference number 528 indicates a region in which analog RF signals travel or are processed. The architecture also includes a local oscillator A 530, a local oscillator B 532, and a controller/processor 534. In some aspects, controller/processor 534 corresponds to controller/processor 240 of the network node 110 described above in connection with FIG. 2 or controller/processor 280 of the UE 120 described above in connection with FIG. 2.

Each of the antenna elements 520 may include one or more sub-elements for radiating or receiving RF signals. For example, a single antenna element 520 may include a first sub-element cross-polarized with a second sub-element that can be used to independently transmit cross-polarized signals. The antenna elements 520 may include patch antennas, dipole antennas, or other types of antennas arranged in a linear pattern, a two dimensional pattern, or another pattern. A spacing between antenna elements 520 may be such that signals with a desired wavelength transmitted separately by the antenna elements 520 may interact or interfere (for example, to form a desired beam). For example, given an expected range of wavelengths or frequencies, the spacing may provide a quarter wavelength, half wavelength, or other fraction of a wavelength of spacing between neighboring antenna elements 520 to allow for interaction or interference of signals transmitted by the separate antenna elements 520 within that expected range.

The modem 502 processes and generates digital baseband signals and may also control operation of the DAC 504, first and second mixers 506, 508, splitter 510, first amplifiers 512, phase shifters 514, or the second amplifiers 516 to transmit signals via one or more or all of the antenna elements 520. The modem 502 may process signals and control operation in accordance with a communication standard such as a wireless standard discussed herein. The DAC 504 may convert digital baseband signals received from the modem 502 (and that are to be transmitted) into analog baseband signals. The first mixer 506 upconverts analog baseband signals to analog IF signals within an IF using a local oscillator A 530. For example, the first mixer 506 may mix the signals with an oscillating signal generated by the local oscillator A 530 to “move” the baseband analog signals to the IF. In some cases, some processing or filtering (not shown) may take place at the IF. The second mixer 508 upconverts the analog IF signals to analog RF signals using the local oscillator B 532. Similar to the first mixer, the second mixer 508 may mix the signals with an oscillating signal generated by the local oscillator B 532 to “move” the IF analog signals to the RF or the frequency at which signals will be transmitted or received. The modem 502 or the controller/processor 534 may adjust the frequency of local oscillator A 530 or the local oscillator B 532 so that a desired IF or RF frequency is produced and used to facilitate processing and transmission of a signal within a desired bandwidth.

In the illustrated architecture 500, signals upconverted by the second mixer 508 are split or duplicated into multiple signals by the splitter 510. The splitter 510 in architecture 500 splits the RF signal into multiple identical or nearly identical RF signals. In other examples, the split may take place with any type of signal, including with baseband digital, baseband analog, or IF analog signals. Each of these signals may correspond to an antenna element 520, and the signal travels through and is processed by amplifiers 512, 516, phase shifters 514, or other elements corresponding to the respective antenna element 520 to be provided to and transmitted by the corresponding antenna element 520 of the antenna array 518. In one example, the splitter 510 may be an active splitter that is connected to a power supply and provides some gain so that RF signals exiting the splitter 510 are at a power level equal to or greater than the signal entering the splitter 510. In another example, the splitter 510 is a passive splitter that is not connected to power supply, and the RF signals exiting the splitter 510 may be at a power level lower than the RF signal entering the splitter 510.

After being split by the splitter 510, the resulting RF signals may enter an amplifier, such as a first amplifier 512, or a phase shifter 514 corresponding to an antenna element 520. The first and second amplifiers 512, 516 are illustrated with dashed lines because one or both of them might not be necessary in some aspects. In some aspects, both the first amplifier 512 and second amplifier 516 are present. In some aspects, neither the first amplifier 512 nor the second amplifier 516 is present. In some aspects, one of the two amplifiers 512, 516 is present but not the other. By way of example, if the splitter 510 is an active splitter, the first amplifier 512 may not be used. By way of further example, if the phase shifter 514 is an active phase shifter that can provide a gain, the second amplifier 516 might not be used.

The amplifiers 512, 516 may provide a desired level of positive or negative gain. A positive gain (positive dB) may be used to increase an amplitude of a signal for radiation by a specific antenna element 520. A negative gain (negative dB) may be used to decrease an amplitude or suppress radiation of the signal by a specific antenna element. Each of the amplifiers 512, 516 may be controlled independently (for example, by the modem 502 or the controller/processor 534) to provide independent control of the gain for each antenna element 520. For example, the modem 502 or the controller/processor 534 may have at least one control line connected to each of the splitter 510, first amplifiers 512, phase shifters 514, or second amplifiers 516 that may be used to configure a gain to provide a desired amount of gain for each component and thus each antenna element 520.

The phase shifter 514 may provide a configurable phase shift or phase offset to a corresponding RF signal to be transmitted. The phase shifter 514 may be a passive phase shifter not directly connected to a power supply. Passive phase shifters might introduce some insertion loss. The second amplifier 516 may boost the signal to compensate for the insertion loss. The phase shifter 514 may be an active phase shifter connected to a power supply such that the active phase shifter provides some amount of gain or prevents insertion loss. The settings of each of the phase shifters 514 are independent, meaning that each can be independently set to provide a desired amount of phase shift or the same amount of phase shift or some other configuration. The modem 502 or the controller/processor 534 may have at least one control line connected to each of the phase shifters 514 and which may be used to configure the phase shifters 514 to provide a desired amount of phase shift or phase offset between antenna elements 520.

In the illustrated architecture 500, RF signals received by the antenna elements 520 are provided to one or more first amplifiers 556 to boost the signal strength. The first amplifiers 556 may be connected to the same antenna arrays 518 (for example, for time division duplex (TDD) operations). The first amplifiers 556 may be connected to different antenna arrays 518. The boosted RF signal is input into one or more phase shifters 554 to provide a configurable phase shift or phase offset for the corresponding received RF signal to enable reception via one or more Rx beams. The phase shifter 554 may be an active phase shifter or a passive phase shifter. The settings of the phase shifters 554 are independent, meaning that each can be independently set to provide a desired amount of phase shift or the same amount of phase shift or some other configuration. The modem 502 or the controller/processor 534 may have at least one control line connected to each of the phase shifters 554 and which may be used to configure the phase shifters 554 to provide a desired amount of phase shift or phase offset between antenna elements 520 to enable reception via one or more Rx beams.

The outputs of the phase shifters 554 may be input to one or more second amplifiers 552 for signal amplification of the phase shifted received RF signals. The second amplifiers 552 may be individually configured to provide a configured amount of gain. The second amplifiers 552 may be individually configured to provide an amount of gain to ensure that the signals input to combiner 550 have the same magnitude. The amplifiers 552 or 556 are illustrated in dashed lines because they might not be necessary in some aspects. In some aspects, both the amplifier 552 and the amplifier 556 are present. In another aspect, neither the amplifier 552 nor the amplifier 556 are present. In other aspects, one of the amplifiers 552, 556 is present but not the other.

In the illustrated architecture 500, signals output by the phase shifters 554 (via the amplifiers 552 when present) are combined in combiner 550. The combiner 550 in architecture 500 combines the RF signal into a signal. The combiner 550 may be a passive combiner (for example, not connected to a power source), which may result in some insertion loss. The combiner 550 may be an active combiner (for example, connected to a power source), which may result in some signal gain. When combiner 550 is an active combiner, it may provide a different (for example, configurable) amount of gain for each input signal so that the input signals have the same magnitude when they are combined. When combiner 550 is an active combiner, the combiner 550 may not need the second amplifier 552 because the active combiner may provide the signal amplification.

The output of the combiner 550 is input into mixers 548 and 546. Mixers 548 and 546 generally down convert the received RF signal using inputs from local oscillators 572 and 570, respectively, to create intermediate or baseband signals that carry the encoded and modulated information. The output of the mixers 548 and 546 are input into an analog-to-digital converter (ADC) 544 for conversion to digital signals. The digital signals output from ADC 544 are input to modem 502 for baseband processing, such as decoding, de-interleaving, or similar operations.

The architecture 500 is given by way of example only to illustrate an architecture for transmitting or receiving signals. In some cases, the architecture 500 or each portion of the architecture 500 may be repeated multiple times within an architecture to accommodate or provide an arbitrary number of RF chains, antenna elements, or antenna panels. Furthermore, numerous alternate architectures are possible and contemplated. For example, although only a single antenna array 518 is shown, two, three, or more antenna arrays may be included, each with one or more of their own corresponding amplifiers, phase shifters, splitters, mixers, DACs, ADCs, or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (for example, represented by different ones of the reference numbers 522, 524, 526, 528) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 510, amplifiers 512, 516, or phase shifters 514 may be located between the DAC 504 and the first mixer 506 or between the first mixer 506 and the second mixer 508. In one example, the functions of one or more of the components may be combined into one component. For example, the phase shifters 514 may perform amplification to include or replace the first or or second amplifiers 512, 516. By way of another example, a phase shift may be implemented by the second mixer 508 to obviate the need for a separate phase shifter 514. This technique is sometimes called local oscillator (LO) phase shifting. In some aspects of this configuration, there may be multiple IF to RF mixers (for example, for each antenna element chain) within the second mixer 508, and the local oscillator B 532 may supply different local oscillator signals (with different phase offsets) to each IF to RF mixer.

The modem 502 or the controller/processor 534 may control one or more of the other components 504 through 572 to select one or more antenna elements 520 or to form beams for transmission of one or more signals. For example, the antenna elements 520 may be individually selected or deselected for transmission of a signal (or signals) by controlling an amplitude of one or more corresponding amplifiers, such as the first amplifiers 512 or the second amplifiers 516. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 520, the radiated signals interact, interfere (constructive and destructive interference), and amplify each other to form a resulting beam. The shape (such as the amplitude, width, or presence of side lobes) and the direction (such as an angle of the beam relative to a surface of the antenna array 518) can be dynamically controlled by modifying the phase shifts or phase offsets imparted by the phase shifters 514 and amplitudes imparted by the amplifiers 512, 516 of the multiple signals relative to each other. The controller/processor 534 may be located partially or fully within one or more other components of the architecture 500. For example, the controller/processor 534 may be located within the modem 502 in some aspects.

In some wireless communication devices, a configuration of the components of the architecture 500 may affect a steering angle of signals transmitted via the antenna elements 520. Additionally or alternatively, a frequency of the signals (for example, a carrier frequency) may affect the steering angle of the signals based on the configuration of the components of the architecture 500. For example, a signal having a first precoding applied may be steered at a first angle when transmitted using a first frequency and may be steered at a second angle when transmitted using a second frequency. A difference between the first frequency and the second frequency, or a ratio of the first frequency and the second frequency, may affect a difference between the first angle and the second angle.

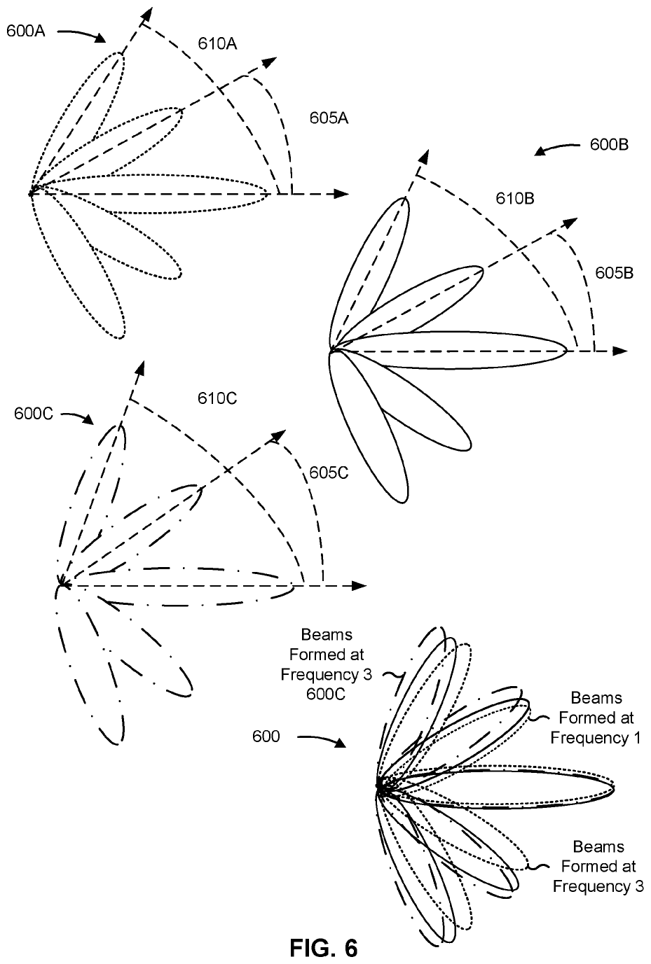

FIG. 6 is a diagram illustrating an example of a set 600 of beam directions formed using a same precoding vector or weights for a signal transmitted on different frequencies. As shown in FIG. 6, the set 600 of beam directions includes a first subset 600A of beam direction from which a transmitting wireless communication device can select for transmission of signaling at a first frequency. The set 600 of beam directions includes a second subset 600B of beam direction from which a transmitting wireless communication device can select for transmission of signaling at a second frequency. The set 600 of beam directions includes a third subset 600C of beam direction from which a transmitting wireless communication device can select for transmission of signaling at a third frequency.

As shown in subset 600A, a first precoding vector may be applied to transmit the signal at the first frequency with a first direction (for example, orthogonal to a plane of antenna elements used to transmit). A second precoding vector may be applied to transmit the signal at the first frequency with a second direction that is at a first angle 605A from the first direction. A third precoding vector may be applied to transmit the signal at the first frequency with a third direction that is at a second angle 605B from the first direction.

As shown in subset 600B, a second precoding vector may be applied to transmit the signal at the second frequency with a first direction (for example, orthogonal to a plane of antenna elements used to transmit). A second precoding vector may be applied to transmit the signal at the second frequency with a second direction that is at a first angle 605B from the first direction. A third precoding vector may be applied to transmit the signal at the second frequency with a third direction that is at a second angle 605B from the first direction.

As shown in subset 600C, a third precoding vector may be applied to transmit the signal at the third frequency with a first direction (for example, orthogonal to a plane of antenna elements used to transmit). A second precoding vector may be applied to transmit the signal at the third frequency with a second direction that is at a first angle 605C from the first direction. A third precoding vector may be applied to transmit the signal at the third frequency with a third direction that is at a second angle 605C from the first direction.

Based on differences between the first frequency, the second frequency, and the third frequency, the angles 605A, 605B, and 605C may be different from each other. Additionally or alternatively, the angles 610A, 610B, and 610C may be different from each other. The amounts of differences in the angles may be based on amounts of differences in the frequencies. For example, a relatively large difference in the first frequency and the third frequency may result in a relatively large difference in the first angle 605A and the first angle 605C. Similarly, a relatively large difference in the first frequency and the second frequency may result in a relatively small difference in the first angle 605A and the first angle 605B.

In some networks, a difference between angles 610A, 610B, and 610C may be larger than differences between angles 605A, 605B, and 605C. This may be caused by, for example, variations of steering for different frequencies being based on an intended steering angle relative to a beam that is perpendicular to the plane of the antenna elements.

As shown in the set 600, when transmitting signals on a frequency bandwidth that spans the first frequency, the second frequency, and the third frequency, frequency-dependent beam directions may cause a blurring of angles of the signals across the frequency bandwidth. In this way, a portion of the signals transmitted over the first frequency may travel in a different direction than a portion of the signals transmitted over the second frequency.

As described herein, beamforming may be used to direct communications along a beam path toward a receiving wireless communication device. A transmitting wireless communication device may apply precoding to a signal before providing the signal to antenna elements for transmission. The precoding provides the signal with timing, rotation, or weighting that, when transmitted via respective antenna elements, steers the signal with a directional beam. In some devices, spacing of the antenna elements is also configured to assist in steering the signal. However, the spacing of the antenna elements may steer the signal to different angles based on frequencies (for example, carrier frequencies) of the signal. In some networks, the transmitting wireless communication device may transmit a communication having signals using a broad frequency bandwidth where a variation of steering at a low end of the frequency bandwidth and steering at a high end of the frequency bandwidth causes reduced signal strength as received at a receiving wireless communication device, which may cause communication errors that consume power, processing, communication, and network resources to detect and correct. Additionally or alternatively, the communication errors may cause wireless communication devices to limit a size of the frequency bandwidth to reduce the variation at ends of the frequency bandwidth.

Various aspects relate generally to beam reports that indicate beams for different FRUs of a frequency bandwidth used for communication between a UE and a network node. Some aspects more specifically relate to indicating multiple FRUs of the frequency bandwidth and indicating a preferred beam for respective FRUs of the multiple FRUs. In some aspects, the beam report may be a multi-part beam report. The multi-part beam report may include a first part that indicates a quantity of beams or a quantity of FRUs that are indicated in a second part of the report. The first part may have a fixed payload size. The second part may indicate pairs of beams and FRUs. For example, the second part may indicate a first FRU of the FRUs and an association with a first beam of the beams (for example, a first recommended beam that is recommended to be used with the first FRU). Additionally or alternatively, the second part may indicate a second FRU of the FRUs and an association with a second beam of the beams.

Particular aspects of the subject matter described in this disclosure can be implemented to realize one or more of the following potential advantages. In some examples, the described techniques can be used to reduce communication errors associated with variation in steering angles of signals at ends of a frequency bandwidth used for a communication.

In some aspects described herein, a UE may be configured (for example, via a communication protocol or via configuration information) to transmit a beam report that indicates different beams for different FRUs. For example, the UE may be configured to transmit the beam report that indicates different beams for different FRUs based on observing effects of frequency-dependent beam directions in RSs transmitted by a network node (referred to as a beam squint). The UE may also be configured to transmit the beam report with a single beam indicated for an entire frequency bandwidth used for communications with the network node (for example, an entire frequency bandwidth of a component carrier).

The beam report may include multiple parts (for example, a multi-stage beam report). A first part may have a fixed payload and may indicate a number of preferred beams and a granularity (for example, an indication of a number of FRUs or a size of the FRUs). A second part may include a variable payload that indicates per-beam or per-FRU information.

In some aspects, the first part may include an indication of a quantity of preferred beams (Nbeam). The indication may use ┌log2maxNrofBeam┐ bits. The first part may include a quantity of FRUs (NFRU). The indication may use ┌log2maxNroffRU┐ bits. The values of maxNrofBeam and maxNroff RU may be configured by a network node or within a communication protocol. The network node may indicate maxNrofBeam to limit the number quantity of preferred beams that may be reported by the UE, with the limit based on a capability of the network node (for example, hardware restrictions, a quantity of transmission antenna panels, a quantity of reception antenna panels, or power constraints, among other examples). A value of maxNroff RU may be based on a bandwidth size or carrier frequency used for the communication.

In some aspects, the second part may include a beam indication. The beam indication may include a per-beam indication that maps each beam to a respective FRU. Additionally or alternatively, the indication may include a per-FRU indication that maps each FRU to a respective beam. In some aspects, whether the beam indication includes a per-beam indication or a per FRU indication may be configured by a network node or in a communication protocol.

In some aspects, the second part may include a signal strength indication. For example, the signal strength indication may indicate an RSRP of RSs received via a reported beam or FRU. The signal strength indication may include a per-beam indication that indicates signal strengths for respective beams. Additionally or alternatively, the indication may include a per-FRU indication that indicates signal strengths for respective FRUs. In some aspects, whether the signal strength indication includes a per-beam indication or a per FRU indication may be configured by a network node or in a communication protocol.

In some examples, a UE may receive RSs over a frequency bandwidth that includes 48 physical resource blocks (PRBs). The PRBs may be divided into 12 subbands, each of which including 4 PRBs. The UE may measure the RSs to perceive three RSs (for example, repetitions of a 3 RSs) transmitted using three different beams (for example, one RS per beam of the three different beams). Within a configured component carrier that includes all of the 12 subbands, the UE may have a beam preference, such as a preference for a first beam (denoted by beam A) for subbands 1-4, a preference for a second beam (denoted by beam B) for subbands 5-12.

The network node may configure the UE with maxNrofBeam=2, maxNroffRU=4. Additionally or alternatively, the network node may configure the UE with maxNrofBeam=2, NroffRU=3, or the network node may configure the UE with NrofBeam=2, maxNrofFRU=4, among other examples.

A beam report may include a first part that indicates (for example, with 3 bits), Nbeam=2 (1 bit) and NFRUJ=3 (2 bits). The beam report may include a second part that includes (for example, as a per-beam indication), a beam indication of [1, 0, 0] for the first beam (indicating beam A for FRU1), and a beam indication [0, 1, 1] for the second beam (indicating beam B is for FRU2 and FRU3). The second part may indicate a layer 1 RSRP [RSRP-A, RSRP-B] for the first beam (beam A) and the second beam (beam B).

Based on reporting beams for different FRUs, the UE may reduce communication errors that may have otherwise been caused by a beam squint effect by allowing the UE to select preferred beams for different parts of a frequency bandwidth used for a communication. Additionally or alternatively, the UE may conserve overhead that may have otherwise been used to perform beam management for multiple component carriers that may have otherwise been configured to span the frequency bandwidth.

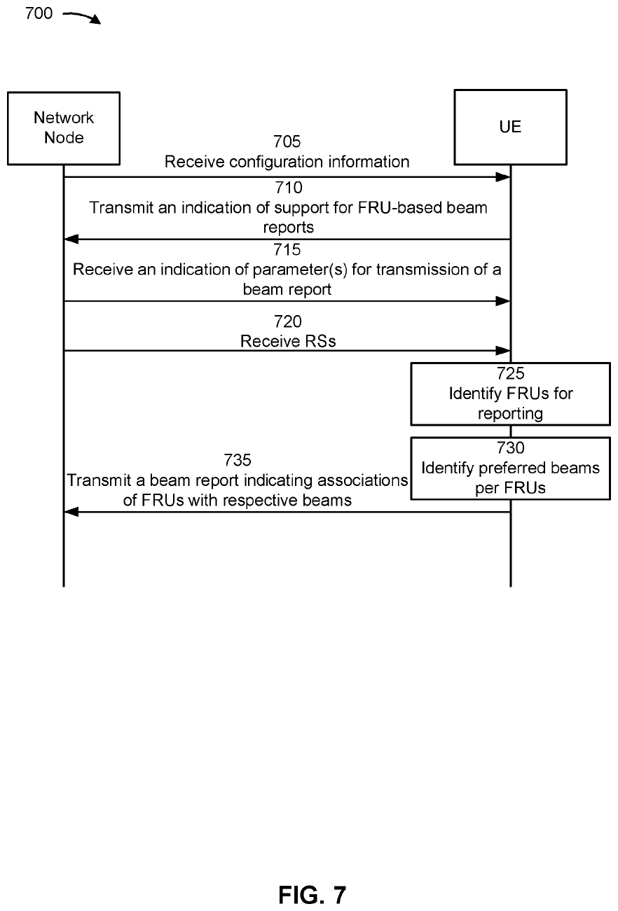

FIG. 7 is a diagram of an example 700 associated with beam reports with FRU granularity, in accordance with the present disclosure. As shown in FIG. 7, a network node (for example, network node 110, a CU, a DU, or an RU) may communicate with a UE (for example, UE 120). In some aspects, the network node and the UE may be part of a wireless network (for example, wireless network 100). The UE and the network node may have established a wireless connection prior to operations shown in FIG. 7. In some aspects, the UE and the network node may communication using a frequency bandwidth that is in a sub-terahertz (sub-ThZ) frequency range.

In a first operation 705, the network node may transmit, and the UE may receive, configuration information. In some aspects, the UE may receive the configuration information via one or more of RRC signaling, one or more MAC-CEs, or DCI, among other examples. In some aspects, the configuration information may include an indication of one or more configuration parameters (for example, already known to the UE or previously indicated by the network node or other network device) for selection by the UE, or explicit configuration information for the UE to use to configure the UE, among other examples.

In some aspects, the configuration information may indicate that the UE is to transmit an indication of support for FRU-based beam reports. The UE may configure itself based on the configuration information. In some aspects, the UE may be configured to perform one or more operations described herein based on the configuration information.

In a second operation 710, the UE may transmit, and the network node may receive, an indication of support for FRU-based beam reports. For example, the UE may support FRU-based beam reports based on available computing resources, available communication resources (for example, antenna ports or antenna panels), or available power resources (for example, available power to perform computing or reception operations).

In a third operation 715, the UE may receive, and the network node may transmit, an indication of one or more parameters for transmission of a beam report. For example, the one or more parameters may indicate that the UE is to transmit a beam report that is FRU-based. In some aspects, the one or more parameters may indicate that the UE is to transmit the beam report with a per-FRU indication of beams or a per-beam indication of FRUs. In some aspects, the one or more parameters may indicate that the UE is to transmit the beam report with a per-FRU indication of signal strength or a per-beam indication of signal strength.

In some aspects, the one or more parameters may indicate a format for transmitting the beam report. For example, the one or more parameters may indicate to transmit the beam report as a multi-part beam report (for example, a multi-stage report). In some aspects, the format may include an indication of locations or sizes of information elements within the multi-part report.

In some aspects, the one or more parameters may indicate a quantity of beams to be indicated in the multi-part beam report or a quantity of FRUs to be indicated in the multi-part beam report. In some aspects, the one or more parameters may indicate a maximum quantity of beams to be indicated in the multi-part beam report or a maximum quantity of FRUs to be indicated in the multi-part beam report.

In some aspects, the network node may select the one or more parameters based on a capability of the network node, power resources of the network node, a size of the frequency bandwidth, or a carrier frequency of the frequency bandwidth, among other examples. In some aspects, the network node may select the one or more parameters based on a capability of the UE to perform per-FRU beam reporting.

In a fourth operation 720, the UE may receive, and the network node may transmit, RSs. In some aspects, the RSs may include CSI-RSs or SSBs.

The network node may transmit one RS (for example, including repetitions) per transmission beam of the network node. In some aspects, the network node may transmit the RSs as a beam sweeping operation over available beams. The UE may measure each RS (for example, to determine a signal strength) using multiple beams to determine a preferred beam (for example, a network node transmission beam) for the network node to use for transmitting to the UE using the frequency bandwidth. The UE may also determine a preferred UE reception beam to pair with the preferred beam.

In a fifth operation 725, the UE may determine FRUs for reporting. For example, the UE may determine a quantity of FRUs to report. The quantity of FRUs to report may be based on the one or more parameters indicated in connection with the third operation 715 or a variation of signal strength of the RSs as received on different parts of the frequency bandwidth. In some aspects, the quantity of FRUs or a quantity of beams may be based on a frequency-dependent beam direction shift for precoding vectors when using frequencies within the frequency bandwidth.

For example, the UE may determine to report a relatively high quantity of FRUs based on a relatively large variation of signal strengths of an RS as measured at a high end of the frequency bandwidth and at a low end of the frequency bandwidth. Additionally or alternatively, the UE may determine to report a quantity of FRUs that is based on a quantity of beams having a highest signal strength at one or more ranges of the frequency bandwidth. For example, if a first beam has a highest signal strength at a first range of the frequency bandwidth and a second beam has a highest signal strength at a second range of the frequency bandwidth, the UE may determine to report two or more FRUs (for example, based on where a change of beams with highest signal strength occurs).

In some aspects, each of the FRUs may have an equal bandwidth size. For example, each of the FRUs may include a same quantity of PRBs. In some aspects, if a quantity of PRBs prohibits an equal quantity of PRBs in each FRU, a configuration or communication protocol may indicate which FRUs are to include a higher or lower quantity of PRBs.

In a sixth operation 730, the UE may identify preferred beams per FRU. For example, based on identifying the FRUs, the UE may identify a preferred beam for each of the identified FRUs based on measured signal strengths of the RSs within the FRUs. In some aspects, the UE may be limited by a maximum number of beams that may be reported, and the UE may report a beam that is does not have the highest signal strength for each FRU, but may instead report beams for each of the FRUs that result in a highest combined signal strength over all of the FRUs.

In a seventh operation 735, the UE may transmit, and the network node may receive a beam report indicating associations of FRUs with respective beams. In some aspects, the beam report may indicate based on the measurements of the RSs, associations between beams and FRUs. For example, the beam report may indicate, based on the measurements of the plurality of RSs, an association of a first beam with a first FRU of the FRUs, and an association of a second beam with a second FRU of the FRUs.

In some aspects, the beam report may include a multi-part beam report. The multi-part beam report may include a first part that indicates, based on measurements of the plurality of RSs, one or more of a quantity of beams indicated in the multi-part report, or a quantity of FRUs indicated in the multi-part beam report. The first part may have fixed payload size. The multi-part beam report may include a second part that indicates, based on the measurements of the plurality of RSs, an association of a beams with FRUs. The second part may have a payload size that is based on the first part. For example, the first part may indicate the payload size of the second part based on an indication of a number of beams reported or a number of FRUs reported.

Based on reporting beams for different FRUs, the UE may reduce communication errors that may have otherwise been caused by a beam squint effect by allowing the UE to select preferred beams for different parts of a frequency bandwidth used for a communication. Additionally or alternatively, the UE may conserve overhead that may have otherwise been used to perform beam management for multiple component carriers that may have otherwise been configured to span the frequency bandwidth.

FIG. 8 is a flowchart illustrating an example process 800 performed, for example, by a UE that supports for beam reports with FRU granularity in accordance with the present disclosure. Example process 800 is an example where the UE (for example, UE 120) performs operations associated with beam reports with FRU granularity.

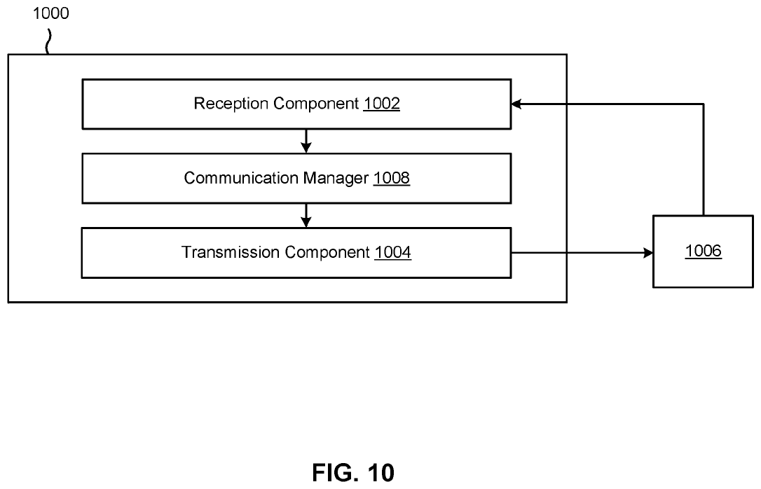

As shown in FIG. 8, in some aspects, process 800 may include receiving an indication of one or more parameters for transmission of a multi-part beam report associated with a beam management procedure (block 810). For example, the UE (such as by using communication manager 140 or reception component 1002, depicted in FIG. 10) may receive an indication of one or more parameters for transmission of a multi-part beam report associated with a beam management procedure, as described above.

As further shown in FIG. 8, in some aspects, process 800 may include receiving a plurality of RSs over a frequency bandwidth, each RS of the plurality of RSs being associated with a respective candidate beam of a plurality of candidate beams (block 820). For example, the UE (such as by using communication manager 140 or reception component 1002, depicted in FIG. 10) may receive a plurality of RSs over a frequency bandwidth, each RS of the plurality of RSs being associated with a respective candidate beam of a plurality of candidate beams, as described above.

As further shown in FIG. 8, in some aspects, process 800 may include transmitting the multi-part beam report based on the one or more parameters (block 830). For example, the UE (such as by using communication manager 140 or transmission component 1004, depicted in FIG. 10) may transmit the multi-part beam report based on the one or more parameters. The multi-part beam report may include: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs, as described above.

Process 800 may include additional aspects, such as any single aspect or any combination of aspects described below or in connection with one or more other processes described elsewhere herein.

In a first additional aspect, the plurality of RSs comprises one or more of CSI-RSs, or SSBs.

In a second additional aspect, alone or in combination with the first aspect, the first part has a fixed payload size, and wherein the second part has a payload size that is based on the first part.

In a third additional aspect, alone or in combination with one or more of the first and second aspects, the quantity of beams or the quantity of FRUs is based on a frequency-dependent beam direction shift for precoding vectors when using frequencies within the frequency bandwidth.

In a fourth additional aspect, alone or in combination with one or more of the first through third aspects, the one or more parameters comprise one or more of the quantity of beams to be indicated in the multi-part beam report, the quantity of FRUs to be indicated in the multi-part beam report, a maximum quantity of beams to be indicated in the multi-part beam report, or a maximum quantity of FRUs to be indicated in the multi-part beam report.

In a fifth additional aspect, alone or in combination with one or more of the first through fourth aspects, the one or more parameters are based on one or more of a capability of a network node associated with the beam management procedure, power resources of the network node, a size of the frequency bandwidth, or a carrier frequency of the frequency bandwidth.

In a sixth additional aspect, alone or in combination with one or more of the first through fifth aspects, process 800 includes the second part includes a plurality of per-beam indications of one or more FRUs, of the FRUs, associated with respective beams of the plurality of candidate beams, or the second part includes a plurality of per-FRU indications of one or more beams, of the plurality of candidate beams, associated with respective FRUs of the FRUs.

In a seventh additional aspect, alone or in combination with one or more of the first through sixth aspects, the second part indicates each of the association of the first beam with the first FRU of the frequency bandwidth and the association of the second beam with the second FRU of the frequency bandwidth based on a respective per-beam indication of an associated signal strength, or a respective per-FRU indication of an associated signal strength.

In an eighth additional aspect, alone or in combination with one or more of the first through seventh aspects, the multi-part beam report indicates that the first beam is a preferred beam for the first FRU and that the second beam is a preferred beam for the second FRU.

In a ninth additional aspect, alone or in combination with one or more of the first through eighth aspects, each of the FRUs has an equal bandwidth size.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a network node that supports beam reports with FRU granularity in accordance with the present disclosure. Example process 900 is an example where the network node (for example, network node 110) performs operations associated with beam reports with frequency resource unit granularity.

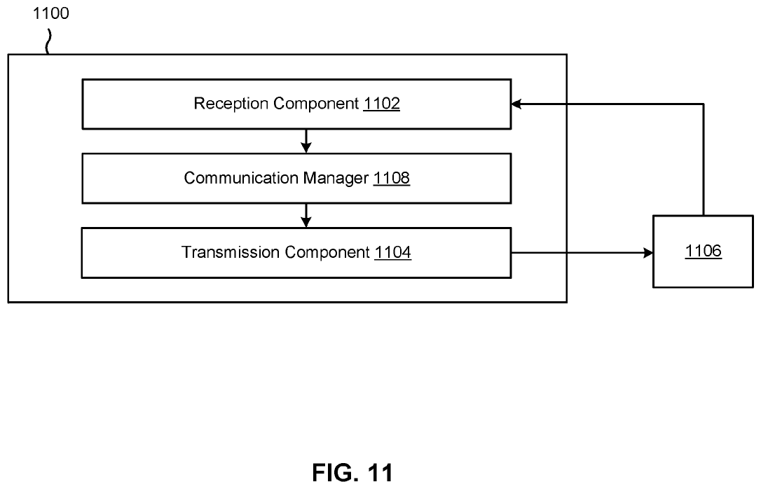

As shown in FIG. 9, in some aspects, process 900 may include transmitting an indication of one or more parameters for transmission of a multi-part beam report associated with a beam management procedure (block 910). For example, the network node (such as by using communication manager 150 or transmission component 1104, depicted in FIG. 11) may transmit an indication of one or more parameters for transmission of a multi-part beam report associated with a beam management procedure, as described above.

As further shown in FIG. 9, in some aspects, process 900 may include transmitting a plurality of RSs over a frequency bandwidth, each RS of the plurality of RSs being associated with a respective candidate beam of a plurality of candidate beams (block 920). For example, the network node (such as by using communication manager 150 or transmission component 1104, depicted in FIG. 11) may transmit a plurality of RSs over a frequency bandwidth, each RS of the plurality of RSs being associated with a respective candidate beam of a plurality of candidate beams, as described above.

As further shown in FIG. 9, in some aspects, process 900 may include receiving the multi-part beam report based on the one or more parameters (block 930). For example, the network node (such as by using communication manager 150 or reception component 1102, depicted in FIG. 11) may receive the multi-part beam report based on the one or more parameters. The multi-part beam report may include: a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs, as described above.

Process 900 may include additional aspects, such as any single aspect or any combination of aspects described below or in connection with one or more other processes described elsewhere herein.

In a first additional aspect, the plurality of RSs comprises one or more of CSI-RSs, or SSBs.

In a second additional aspect, alone or in combination with the first aspect, the first part has a fixed payload size, and wherein the second part has a payload size that is based on the first part.

In a third additional aspect, alone or in combination with one or more of the first and second aspects, the quantity of beams or the quantity of FRUs is based on a frequency-dependent beam direction shift for precoding vectors when using frequencies within the frequency bandwidth.

In a fourth additional aspect, alone or in combination with one or more of the first through third aspects, the one or more parameters comprise one or more of the quantity of beams to be indicated in the multi-part beam report, the quantity of FRUs to be indicated in the multi-part beam report, a maximum quantity of beams to be indicated in the multi-part beam report, or a maximum quantity of FRUs to be indicated in the multi-part beam report.

In a fifth additional aspect, alone or in combination with one or more of the first through fourth aspects, the one or more parameters are based on one or more of a capability of the network node associated with the beam management procedure, power resources of the network node, a size of the frequency bandwidth, or a carrier frequency of the frequency bandwidth.

In a sixth additional aspect, alone or in combination with one or more of the first through fifth aspects, process 900 includes the second part includes a plurality of per-beam indications of one or more FRUs, of the FRUs, associated with respective beams of the plurality of candidate beams, or the second part includes a plurality of per-FRU indications of one or more beams, of the plurality of candidate beams, associated with respective FRUs of the FRUs.

In a seventh additional aspect, alone or in combination with one or more of the first through sixth aspects, the second part indicates each of the association of the first beam with the first FRU of the frequency bandwidth and the association of the second beam with the second FRU of the frequency bandwidth based on a respective per-beam indication of an associated signal strength, or a respective per-FRU indication of an associated signal strength.

In an eighth additional aspect, alone or in combination with one or more of the first through seventh aspects, the multi-part beam report indicates that the first beam is a preferred beam for the first FRU and that the second beam is a preferred beam for the second FRU.

In a ninth additional aspect, alone or in combination with one or more of the first through eighth aspects, each of the FRUs has an equal bandwidth size.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000, for wireless communication, that supports beam reports with FRU granularity, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (for example, the communication manager 140).

In some aspects, the apparatus 1000 may be configured to perform one or more operations described herein in connection with FIG. 7. Additionally or alternatively, the apparatus 1000 may be configured to perform one or more processes described herein, such as process 800 of FIG. 8. In some aspects, the apparatus 1000 or one or more components shown in FIG. 10 may include one or more components of the UE described in connection with FIG. 2. Additionally or alternatively, one or more components shown in FIG. 10 may be implemented within one or more components described in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication of one or more parameters for transmission of a multi-part beam report associated with a beam management procedure. The reception component 1002 may receive a plurality of RSs over a frequency bandwidth, each RS of the plurality of RSs being associated with a respective candidate beam of a plurality of candidate beams. The transmission component 1004 may transmit the multi-part beam report based on the one or more parameters, the multi-part beam report including a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100, for wireless communication, that supports beam reports with FRU granularity, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (for example, the communication manager 150).

In some aspects, the apparatus 1100 may be configured to perform one or more operations described herein in connection with FIG. 7. Additionally or alternatively, the apparatus 1100 may be configured to perform one or more processes described herein, such as process 900. In some aspects, the apparatus 1100 or one or more components shown in FIG. 11 may include one or more components of the network node described in connection with FIG. 2. Additionally or alternatively, one or more components shown in FIG. 11 may be implemented within one or more components described in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit an indication of one or more parameters for transmission of a multi-part beam report associated with a beam management procedure. The transmission component 1104 may transmit a plurality of

RSs over a frequency bandwidth, each RS of the plurality of RSs being associated with a respective candidate beam of a plurality of candidate beams. The reception component 1102 may receive the multi-part beam report based on the one or more parameters, the multi-part beam report including a first part that indicates, based on measurements of the plurality of RSs, one or more of a quantity of beams, of the plurality of candidate beams, indicated in the multi-part report, or a quantity of FRUs, within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication of one or more parameters for transmission of a multi-part beam report associated with a beam management procedure; receiving a plurality of reference signals (RSs) over a frequency bandwidth, each RS of the plurality of RSs being associated with a respective candidate beam of a plurality of candidate beams; and transmitting the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Aspect 2: The method of Aspect 1, wherein the plurality of RSs comprises one or more of: channel state information reference signals (CSI-RSs), or synchronization signal blocks (SSBs).

Aspect 3: The method of any of Aspects 1-2, wherein the first part has a fixed payload size, and wherein the second part has a payload size that is based on the first part.

Aspect 4: The method of any of Aspects 1-3, wherein the quantity of beams or the quantity of FRUs is based on a frequency-dependent beam direction shift for precoding vectors when using frequencies within the frequency bandwidth.

Aspect 5: The method of any of Aspects 1-4, wherein the one or more parameters comprise one or more of: the quantity of beams to be indicated in the multi-part beam report, the quantity of FRUs to be indicated in the multi-part beam report, a maximum quantity of beams to be indicated in the multi-part beam report, or a maximum quantity of FRUs to be indicated in the multi-part beam report.

Aspect 6: The method of any of Aspects 1-5, wherein the one or more parameters are based on one or more of: a capability of a network node associated with the beam management procedure, power resources of the network node, a size of the frequency bandwidth, or a carrier frequency of the frequency bandwidth.

Aspect 7: The method of any of Aspects 1-6, wherein: the second part includes a plurality of per-beam indications of one or more FRUs, of the FRUs, associated with respective beams of the plurality of candidate beams, or the second part includes a plurality of per-FRU indications of one or more beams, of the plurality of candidate beams, associated with respective FRUs of the FRUs.

Aspect 8: The method of any of Aspects 1-7, wherein the second part indicates each of the association of the first beam with the first FRU of the frequency bandwidth and the association of the second beam with the second FRU of the frequency bandwidth based on: a respective per-beam indication of an associated signal strength, or a respective per-FRU indication of an associated signal strength.

Aspect 9: The method of any of Aspects 1-8, wherein the multi-part beam report indicates that the first beam is a preferred beam for the first FRU and that the second beam is a preferred beam for the second FRU.

Aspect 10: The method of any of Aspects 1-9, wherein each of the FRUs has an equal bandwidth size.

Aspect 11: A method of wireless communication performed by a network node, comprising: transmitting an indication of one or more parameters for transmission of a multi-part beam report associated with a beam management procedure; transmitting a plurality of reference signals (RSs) over a frequency bandwidth, each RS of the plurality of RSs being associated with a respective candidate beam of a plurality of candidate beams; and receiving the multi-part beam report based on the one or more parameters, the multi-part beam report including: a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

Aspect 12: The method of Aspect 11, wherein the plurality of RSs comprises one or more of: channel state information reference signals (CSI-RSs), or synchronization signal blocks (SSBs).

Aspect 13: The method of any of Aspects 11-12, wherein the first part has a fixed payload size, and wherein the second part has a payload size that is based on the first part.

Aspect 14: The method of any of Aspects 11-13, wherein the quantity of beams or the quantity of FRUs is based on a frequency-dependent beam direction shift for precoding vectors when using frequencies within the frequency bandwidth.

Aspect 15: The method of any of Aspects 11-14, wherein the one or more parameters comprise one or more of: the quantity of beams to be indicated in the multi-part beam report, the quantity of FRUs to be indicated in the multi-part beam report, a maximum quantity of beams to be indicated in the multi-part beam report, or a maximum quantity of FRUs to be indicated in the multi-part beam report.

Aspect 16: The method of any of Aspects 11-15, wherein the one or more parameters are based on one or more of: a capability of the network node associated with the beam management procedure, power resources of the network node, a size of the frequency bandwidth, or a carrier frequency of the frequency bandwidth.

Aspect 17: The method of any of Aspects 11-16, wherein: the second part includes a plurality of per-beam indications of one or more FRUs, of the FRUs, associated with respective beams of the plurality of candidate beams, or the second part includes a plurality of per-FRU indications of one or more beams, of the plurality of candidate beams, associated with respective FRUs of the FRUs.

Aspect 18: The method of any of Aspects 11-17, wherein the second part indicates each of the association of the first beam with the first FRU of the frequency bandwidth and the association of the second beam with the second FRU of the frequency bandwidth based on: a respective per-beam indication of an associated signal strength, or a respective per-FRU indication of an associated signal strength.

Aspect 19: The method of any of Aspects 11-18, wherein the multi-part beam report indicates that the first beam is a preferred beam for the first FRU and that the second beam is a preferred beam for the second FRU.

Aspect 20: The method of any of Aspects 11-19, wherein each of the FRUs has an equal bandwidth size.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of

instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive an indication of one or more parameters for transmission of a multi-part beam report associated with a beam management procedure;
receive a plurality of reference signals (RSs) over a frequency bandwidth, each RS of the plurality of RSs being associated with a respective candidate beam of a plurality of candidate beams; and
transmit the multi-part beam report based on the one or more parameters, the multi-part beam report including:
a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and
a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

2. The UE of claim 1, wherein the plurality of RSs comprises one or more of:
channel state information reference signals (CSI-RSs), or signal blocks (SSBs).

3. The UE of claim 1, wherein the first part has a fixed payload size, and wherein the second part has a payload size that is based on the first part.

4. The UE of claim 1, wherein the quantity of beams or the quantity of FRUs is based on a frequency-dependent beam direction shift for precoding vectors when using frequencies within the frequency bandwidth.

5. The UE of claim 1, wherein the one or more parameters comprise one or more of:
the quantity of beams to be indicated in the multi-part beam report,
the quantity of FRUs to be indicated in the multi-part beam report,
a maximum quantity of beams to be indicated in the multi-part beam report, or
a maximum quantity of FRUs to be indicated in the multi-part beam report.

6. The UE of claim 1, wherein the one or more parameters are based on one or more of:
a capability of a network node associated with the beam management procedure,
power resources of the network node,
a size of the frequency bandwidth, or
a carrier frequency of the frequency bandwidth.

7. The UE of claim 1, wherein:
the second part includes a plurality of per-beam indications of one or more FRUs, of the FRUs, associated with respective beams of the plurality of candidate beams, or
the second part includes a plurality of per-FRU indications of one or more beams, of the plurality of candidate beams, associated with respective FRUs of the FRUs.

8. The UE of claim 1, wherein the second part indicates each of the association of the first beam with the first FRU of the frequency bandwidth and the association of the second beam with the second FRU of the frequency bandwidth based on:
a respective per-beam indication of an associated signal strength, or
a respective per-FRU indication of an associated signal strength.

9. The UE of claim 1, wherein the multi-part beam report indicates that the first beam is a preferred beam for the first FRU and that the second beam is a preferred beam for the second FRU.

10. The UE of claim 1, wherein each of the FRUs has an equal bandwidth size.

11. A network node for wireless communication, comprising:
at least one memory; and
at least one processor communicatively coupled with the at least one memory, the at least one processor configured to cause the network node to:
transmit an indication of one or more parameters for transmission of a multi-part beam report associated with a beam management procedure;
transmit a plurality of reference signals (RSs) over a frequency bandwidth, each RS of the plurality of RSs being associated with a respective candidate beam of a plurality of candidate beams; and
receive the multi-part beam report based on the one or more parameters, the multi-part beam report including:
a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and
a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

12. The network node of claim 11, wherein the plurality of RSs comprises one or more of:
channel state information reference signals (CSI-RSs), or
signal blocks (SSBs).

13. The network node of claim 11, wherein the first part has a fixed payload size, and
wherein the second part has a payload size that is based on the first part.

14. The network node of claim 11, wherein the quantity of beams or the quantity of FRUs is based on a frequency-dependent beam direction shift for precoding vectors when using frequencies within the frequency bandwidth.

15. The network node of claim 11, wherein the one or more parameters comprise one or more of:
the quantity of beams to be indicated in the multi-part beam report,
the quantity of FRUs to be indicated in the multi-part beam report,
a maximum quantity of beams to be indicated in the multi-part beam report, or
a maximum quantity of FRUs to be indicated in the multi-part beam report.

16. The network node of claim 11, wherein the one or more parameters are based on one or more of:
a capability of the network node associated with the beam management procedure,
power resources of the network node,
a size of the frequency bandwidth, or
a carrier frequency of the frequency bandwidth.

17. The network node of claim 11, wherein:
the second part includes a plurality of per-beam indications of one or more FRUs,
of the FRUs, associated with respective beams of the plurality of candidate beams, or the second part includes a plurality of per-FRU indications of one or more beams, of the plurality of candidate beams, associated with respective FRUs of the FRUs.

18. The network node of claim 11, wherein the second part indicates each of the association of the first beam with the first FRU of the frequency bandwidth and the association of the second beam with the second FRU of the frequency bandwidth based on:
a respective per-beam indication of an associated signal strength, or
a respective per-FRU indication of an associated signal strength.

19. The network node of claim 11, wherein the multi-part beam report indicates that the first beam is a preferred beam for the first FRU and that the second beam is a preferred beam for the second FRU.

20. The network node of claim 11, wherein each of the FRUs has an equal bandwidth size.

21. A method of wireless communication performed by a user equipment (UE), comprising:
receiving an indication of one or more parameters for transmission of a multi-part beam report associated with a beam management procedure;
receiving a plurality of reference signals (RSs) over a frequency bandwidth, each RS of the plurality of RSs being associated with a respective candidate beam of a plurality of candidate beams; and
transmitting the multi-part beam report based on the one or more parameters, the multi-part beam report including:
a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and
a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

22. The method of claim 21, wherein the first part has a fixed payload size, and
wherein the second part has a payload size that is based on the first part.

23. The method of claim 21, wherein the quantity of beams or the quantity of FRUs is based on a frequency-dependent beam direction shift for precoding vectors when using frequencies within the frequency bandwidth.

24. The method of claim 21, wherein the one or more parameters comprise one or more of:
the quantity of beams to be indicated in the multi-part beam report,
the quantity of FRUs to be indicated in the multi-part beam report,
a maximum quantity of beams to be indicated in the multi-part beam report, or
a maximum quantity of FRUs to be indicated in the multi-part beam report.

25. The method of claim 21, wherein:
the second part includes a plurality of per-beam indications of one or more FRUs, of the FRUs, associated with respective beams of the plurality of candidate beams, or
the second part includes a plurality of per-FRU indications of one or more beams, of the plurality of candidate beams, associated with respective FRUs of the FRUs.

26. A method of wireless communication performed by a network node, comprising:
transmitting an indication of one or more parameters for transmission of a multi-part beam report associated with a beam management procedure;
transmitting a plurality of reference signals (RSs) over a frequency bandwidth, each RS of the plurality of RSs being associated with a respective candidate beam of a plurality of candidate beams; and
receiving the multi-part beam report based on the one or more parameters, the multi-part beam report including:
a first part that indicates, based on measurements of the plurality of RSs, one or more of a quantity of beams, of the plurality of candidate beams, indicated in the multi-part report, or a quantity of frequency resource units (FRUs), within the frequency bandwidth, indicated in the multi-part beam report, and
a second part that indicates, based on the measurements of the plurality of RSs, an association of a first beam, of the plurality of candidate beams, with a first FRU of the FRUs, and an association of a second beam, of the plurality of candidate beams, with a second FRU of the FRUs.

27. The method of claim 26, wherein the first part has a fixed payload size, and
wherein the second part has a payload size that is based on the first part.

28. The method of claim 26, wherein the quantity of beams or the quantity of FRUs is based on a frequency-dependent beam direction shift for precoding vectors when using frequencies within the frequency bandwidth.

29. The method of claim 26, wherein the one or more parameters comprise one or more of:
the quantity of beams to be indicated in the multi-part beam report,
the quantity of FRUs to be indicated in the multi-part beam report,
a maximum quantity of beams to be indicated in the multi-part beam report, or
a maximum quantity of FRUs to be indicated in the multi-part beam report.

30. The method of claim 26, wherein:
the second part includes a plurality of per-beam indications of one or more FRUs, of the FRUs, associated with respective beams of the plurality of candidate beams, or
the second part includes a plurality of per-FRU indications of one or more beams, of the plurality of candidate beams, associated with respective FRUs of the FRUs.
